(19) United States
(12) Patent Application Publication
(10) Pub. No.: US 2026/0229739 A1
(43) Pub. Date: Aug. 6, 2026

(54) FUSE UNIT AND CONDUCTIVE MODULE

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/530,361

(22) Filed: Feb. 5, 2026

(30) Foreign Application Priority Data
Feb. 6, 2025 (JP) 2025-018115

(51) Int. Cl. H01M 50/583; H01H 85/02; H01H 85/041

(52) U.S. Cl. CPC H01M 50/583; H01H 85/0241; H01H 85/0411; H01M 2200/103

(57) ABSTRACT

A fuse unit includes a chip fuse, a first terminal fitting that has a first electrical connection portion electrically connected to a first electrode of the chip fuse and is electrically connected to a connection conductor (first connection object), a second terminal fitting that has a second electrical connection portion electrically connected to a second electrode of the chip fuse and is electrically connected to a battery monitoring unit (second connection object), and an extendable shape portion that is provided at at least one of the first terminal fitting and the second terminal fitting, the extendable shape portion enabling the at least one of them to extend and contract along an alignment direction of the first terminal fitting and the second terminal fitting.

### CROSS-REFERENCE TO RELATED APPLICATION(S

The present application claims priority to and incorporates by reference the entire contents of Japanese Patent Application No. 2025-018115 filed in Japan on February 6, 2025.

### BACKGROUND OF THE INVENTION

### 1. Field of the Invention

The present invention relates to a fuse unit and a conductive module.

### 2. Description of the Related Art

The conductive module electrically connects the plurality of battery cells using a plurality of connection conductors in a battery module in which a plurality of battery cells is disposed. Then, the conductive module electrically connects each connection conductor to the battery monitoring unit that monitors the battery state of the battery cell using a routing member such as an electric wire. For example, Japanese Patent Application Laid-open No. JP 2020 - 119 651 A discloses this type of conductive module. In such a conductive module, a combination of a pair of connection conductor and a conductor portion of a routing member is provided for each connection conductor, and a circuit protection component such as a fuse may be interposed between the connection conductor and the conductor portion of the wiring member in each combination. For example, Japanese Patent No. JP 7 561 318 B2 discloses a fuse unit (composed of a chip fuse, a pair of terminal fittings, and a resin member) applied to the conductive module.

In the conventional fuse unit, for example, there is room for further improvement in securing an appropriate connection state with respect to the connection conductor and the conductor portions of the routing member, that is, the first electrical connection object and the second electrical connection object.

### SUMMARY OF THE INVENTION

The present invention has been made in view of the above circumstances, and an object thereof is to provide a fuse unit and a conductive module capable of ensuring an appropriate connection state with respect to a first electrical connection object and a second electrical connection object.

In order to achieve the above mentioned object, a fuse unit according to one aspect of the present invention includes a chip fuse that fuses a fusible portion when an overcurrent flows between a first electrical connection object and a second electrical connection object; a first terminal fitting including a first electrical connection portion electrically connected to a first electrode of the chip fuse, and electrically connected to the first electrical connection object; a second terminal fitting including a second electrical connection portion electrically connected to a second electrode of the chip fuse, and electrically connected to the second electrical connection object; and an extendable shape portion provided at at least one of the first terminal fitting and the second terminal fitting, the extendable shape portion enabling the at least one of the first terminal fitting and the second terminal fitting to extend and contract along an alignment direction of the first terminal fitting and the second terminal fitting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a conductive module to which a fuse unit according to an embodiment is applied;

FIG. 2 is an exemplary perspective view of a battery module and a connection conductor according to the embodiment;

FIG. 3 is an exemplary perspective view of the fuse unit according to the embodiment;

FIG. 4 is an exemplary exploded perspective view of the fuse unit according to the embodiment;

FIG. 5 is an exemplary exploded perspective view of the fuse unit according to the embodiment when viewed from an angle different from that in FIG. 4;

FIG. 6 is an exemplary perspective view of a fuse unit according to the first modification;

FIG. 7 is an exemplary perspective view of a fuse unit according to the first modification when viewed from an angle different from that in FIG. 6;

FIG. 8 is an exemplary perspective view of a fuse unit according to the second modification;

FIG. 9 is an exemplary exploded perspective view of a fuse unit according to the second modification;

FIG. 10 is an exemplary exploded perspective view of a fuse unit according to the second modification when viewed from an angle different from that in FIG. 9;

FIG. 11 is an exemplary side view of a fuse unit according to the second modification; and

FIG. 12 is an exemplary side view of a fuse unit according to the third modification.

### DETAILED DESCRIPTION OF THE PREFERRED EMBODIMENTS

Hereinafter, the embodiment and the modification according to the present invention will be described in detail with reference to the drawings. Note that the present invention is not limited by the embodiment and the modification below. In addition, constituent elements in the following embodiment and modification include those that can be easily replaced by those skilled in the art, or those that are substantially the same.

In addition, the embodiment and the modification disclosed below include similar components. Therefore, in the following description, common reference numerals are given to these similar components, and redundant description is omitted. In the present specification, ordinal numbers are used only to distinguish components, members, parts, positions, directions, and the like, and do not indicate order or priority.

### Embodiments

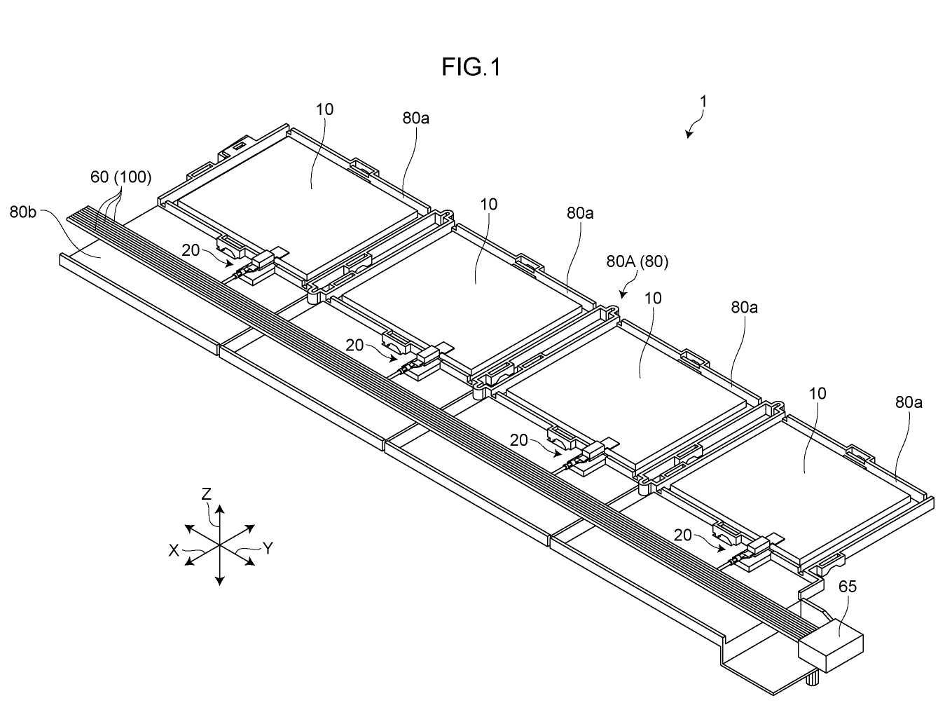

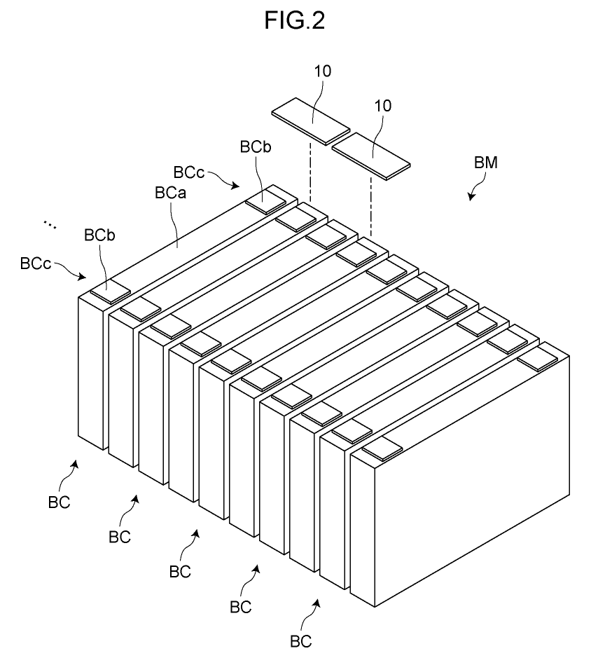

FIG. 1 is a perspective view of a conductive module 1 to which a fuse unit 20 according to an embodiment is applied. The conductive module 1 of the present embodiment illustrated in FIG. 1 is, for example, assembled to a battery module BM in which a plurality of battery cells BC (see FIG. 2) is disposed, and is electrically connected to the plurality of battery cells BC in the battery module BM. In addition, the conductive module 1 causes a battery monitoring unit 100 to monitor the battery state of the battery cell BC by electrically connecting the battery module BM to the battery monitoring unit 100. The conductive module 1 constitutes a battery pack together with the battery module BM. The battery pack is mounted on, for example, a vehicle (BEV: Battery Electric Vehicle, HEV: Hybrid Electric Vehicle, etc.) including a rotary machine as a drive source, and is used for power supply to the rotary machine. In FIG. 1, for convenience, the unit body of the battery monitoring unit 100 is not illustrated, and only a routing member 60 of the battery monitoring unit 100 is illustrated.

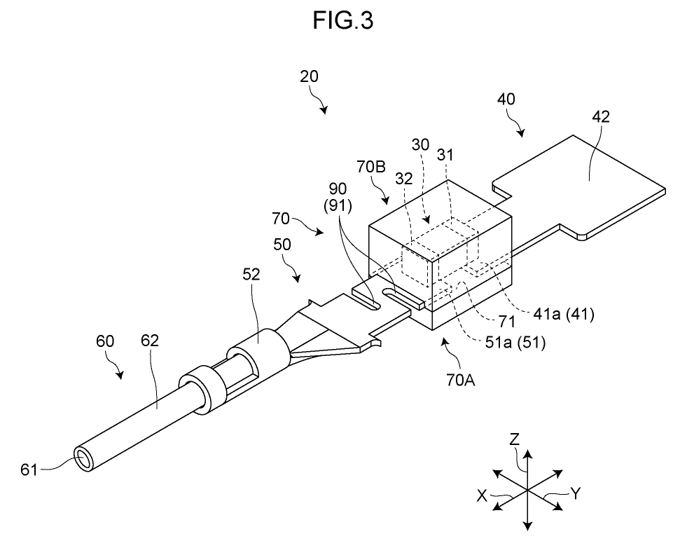

In the following description, among the first direction, the second direction, and the third direction intersecting each other, the first direction is referred to as an "alignment direction X", the second direction is referred to as a "width direction Y", and the third direction is referred to as a "height direction Z". Here, the alignment direction X, the width direction Y, and the height direction Z are substantially orthogonal to each other. Typically, the alignment direction X corresponds to a lateral direction of the conductive module 1, a longitudinal direction of the fuse unit 20, a direction in which a first terminal fitting 40 (see FIG. 3) and a second terminal fitting 50, which will be described later, of the fuse unit 20 are aligned, and the like. The width direction Y typically corresponds to a longitudinal direction of the conductive module 1, a width direction of the fuse unit 20, or the like. The height direction Z typically corresponds to a height direction (vertical direction) or the like of the conductive module 1 and the fuse unit 20. Each direction used in the following description will be described as a direction in a state where the fuse unit 20 is assembled to the conductive module 1 unless otherwise specified.

FIG. 2 is a perspective view of the battery module BM and a connection conductor 10. The battery cell BC includes, for example, a cell body BCa and positive and negative electrode terminals BCb. In the battery module BM, a plurality of battery cells BC is disposed in a row along the arrangement direction (width direction Y). The battery module BM includes one electrode terminal group BCc in which one electrode terminal BCb of the plurality of battery cells BC is disposed along the arrangement direction, and the other electrode terminal group BCc in which the other electrode terminal BCb of the plurality of battery cells BC is disposed along the arrangement direction.

The battery cell BC is formed in, for example, a rectangular parallelepiped shape in which the cell body BCa has six outer wall faces. In the plurality of battery cells BC, cell bodies BCa adjacent to each other in the arrangement direction are disposed with one outer wall face facing each other. For example, in the battery cell BC, the positive and negative electrode terminals BCb are disposed on one of the six outer wall faces of the cell body BCa or in two of the six outer wall faces of the cell body BCa. In this example, each battery cell BC includes positive and negative electrode terminals BCb on one of the six outer wall faces of the cell body BCa. Therefore, in the battery module BM, two electrode terminal groups BCc are provided on one plane.

The electrode terminal BCb is formed in, for example, a flat plate shape, and is directly electrically connected to the connection conductor 10 to be described later by laser welding or the like. However, the electrode terminal BCb may be formed in a pole shape having a male screw portion. In this case, the connection conductor 10 is screwed and fixed to the electrode terminal BCb by screwing a female screw member to the male screw portion of the electrode terminal BCb.

The conductive module 1 includes, for example, the connection conductor 10 that is directly electrically connected to the electrode terminal BCb of the battery cell BC constituting the battery module BM. The connection conductor 10 is formed of a conductive material such as metal. The connection conductor 10 is a metal plate-like conductive component called a bus bar, and is press-molded using a metal plate as a base material, for example. The connection conductor 10 illustrated here is formed in a rectangular flat plate shape.

The conductive module 1 includes, as the connection conductor 10, for example, a conductor that is directly electrically connected to the electrode terminal BCb adjacent to the pair of battery cells BC in the battery module BM, a conductor that is directly electrically connected to the electrode terminal BCb serving as the total negative electrode in the battery module BM, and a conductor that is directly electrically connected to the electrode terminal BCb serving as the total positive electrode in the battery module BM.

The conductive module 1 includes the connection conductor 10 and the fuse unit 20. The fuse unit 20 is connected between the connection conductor 10 and the battery monitoring unit 100. For example, the fuse unit 20 indirectly electrically connects the connection conductor 10 and the battery monitoring unit 100, and interrupts energization when an overcurrent flows therebetween. The fuse unit 20 is provided for each connection conductor 10 (see FIG. 1).

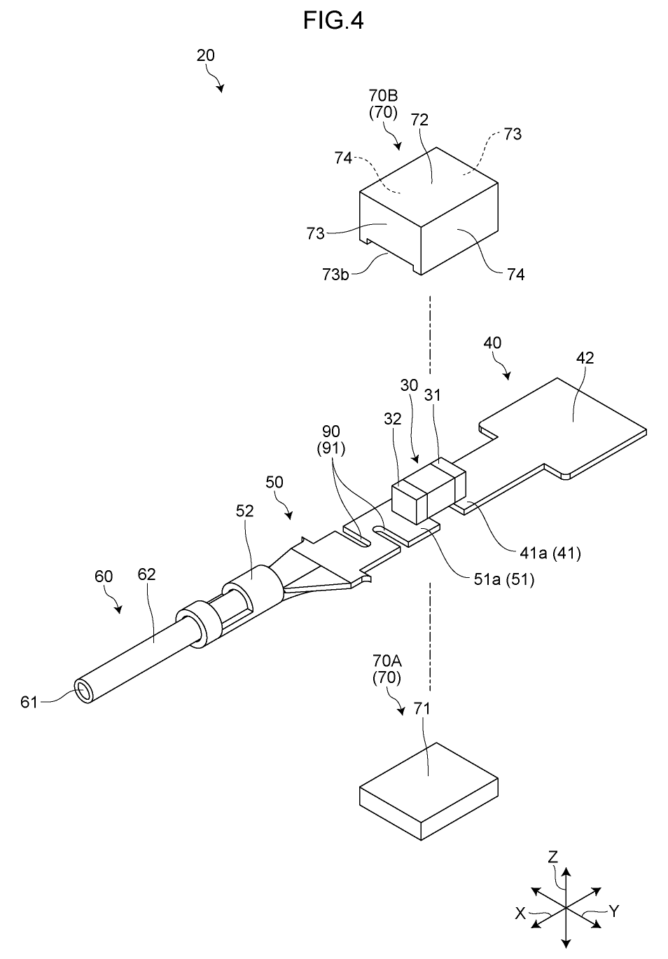

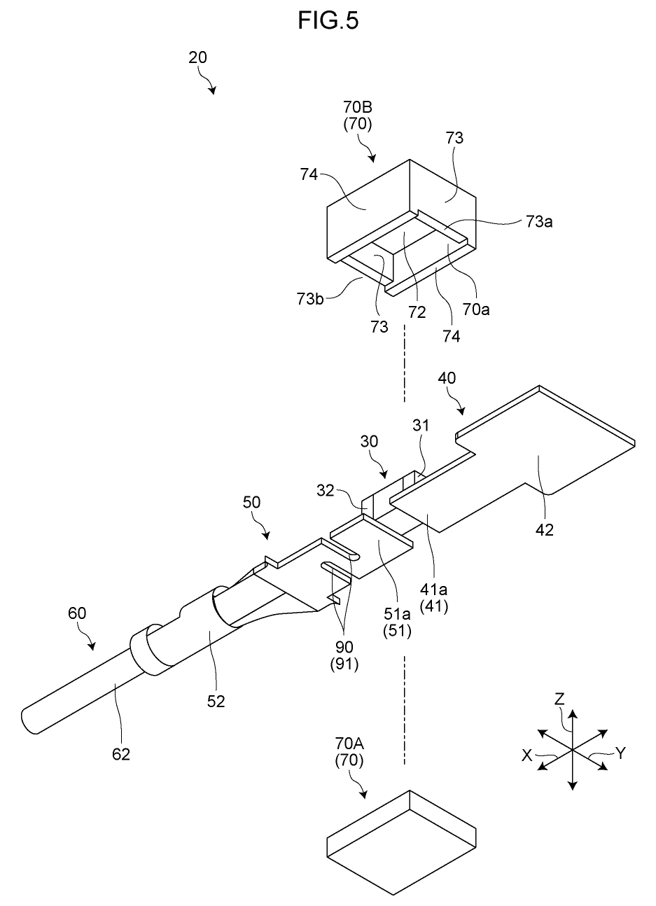

FIG. 3 is a perspective view of the fuse unit 20, FIG. 4 is an exploded perspective view of the fuse unit 20, and FIG. 5 is an exploded perspective view of the fuse unit 20 when viewed from an angle different from that in FIG. 4. As illustrated in FIG. 3 to 5, the fuse unit 20 includes, for example, a chip fuse 30, a first terminal fitting 40, a second terminal fitting 50, and a resin member 70. The chip fuse 30 is a circuit protection component that fuses a fusible portion when an overcurrent flows between the connection conductor 10 and the battery monitoring unit 100 described above. The chip fuse 30 includes, for example, a first electrode 31, a second electrode 32, and a fusible portion disposed between the first electrode 31 and the second electrode 32. The first electrode 31 and the second electrode 32 are disposed on a straight line at one end portion and the other end portion, respectively, of the chip fuse 30 in the alignment direction X.

The chip fuse 30 is, for example, configured as a face-mountable chip component having a fusible portion, configured as a pattern fuse in which a wiring pattern having a fusible portion is provided on a printed circuit board (for example, a flexible printed circuit board), or the like. The chip fuse 30 illustrated here is configured as a rectangular parallelepiped chip component. The first electrode 31 is provided at one end portion of the chip fuse 30 in the alignment direction X, and the second electrode 32 is provided at the other end portion of the chip fuse 30 in the alignment direction X.

The first terminal fitting 40 and the second terminal fitting 50 are directly electrically connected to the chip fuse 30. The first terminal fitting 40 and the second terminal fitting 50 are formed of a conductive material such as metal. Here, the first terminal fitting 40 and the second terminal fitting 50 have, for example, a plate shape, and are formed by press molding using a metal plate as a base material.

The first terminal fitting 40 includes, for example, a first electrical connection portion 41 directly electrically connected to the first electrode 31 of the chip fuse 30. In a state where one of the four outer wall faces of the first electrode 31 disposed in the circumferential direction is placed on the first electrical connection portion 41, the first electrode 31 is directly electrically connected by laser welding, soldering, or the like. Therefore, the first electrical connection portion 41 is formed in a flat plate shape provided with a plane on which the outer wall face of the first electrode 31 is placed. The first electrical connection portion 41 is formed as, for example, a flat plate-shaped narrow portion having a smaller lateral width along the width direction Y than a conductor connection portion 42, and the outer wall face of the first electrode 31 is placed on the narrow portion. In the first electrical connection portion 41, the narrow portion serves as a contact portion 41a with the first electrode 31, and the contact portion 41a and the first electrode 31 are directly and electrically connected.

The conductor connection portion 42 is, for example, electrically connected directly or indirectly to the connection conductor 10. The conductor connection portion 42 is provided at an end portion opposite to the first electrical connection portion 41 in the alignment direction X. The conductor connection portion 42 is formed in a flat plate shape, and is directly electrically connected to the connection conductor 10 by laser welding, ultrasonic bonding, or the like in a state where the planes of the connection conductor 10 and the conductor connection portion 42 overlap with each other. The conductor connection portion 42 illustrated here is formed in a rectangular flat plate shape. The connection conductor 10 is an example of a first electrical connection object connected to the first terminal fitting 40. The first terminal fitting 40 is formed in, for example, one flat plate shape in which the first electrical connection portion 41 and the conductor connection portion 42 are adjacent to each other.

The second terminal fitting 50 includes, for example, a second electrical connection portion 51 directly electrically connected to the second electrode 32 of the chip fuse 30. In a state where one of the four outer wall faces of the second electrode 32 disposed in the circumferential direction is placed on the second electrical connection portion 51, the second electrode 32 is directly electrically connected by laser welding, soldering, or the like. Therefore, the second electrical connection portion 51 is formed in a flat plate shape provided with a plane on which the outer wall face of the second electrode 32 is placed. The second electrical connection portion 51 is formed in, for example, a protruding flat plate shape, and the outer wall face of the second electrode 32 is placed on the protruding narrow portion. In the second electrical connection portion 51, the narrow portion serves as a contact portion 51a with the second electrode 32, and the contact portion 51a and the second electrode 32 are directly and electrically connected.

In addition, the second terminal fitting 50 has a joint portion 52 directly electrically connected to the routing member 60 of the battery monitoring unit 100. The joint portion 52 is provided at an end portion opposite to the second electrical connection portion 51 in the alignment direction X. The battery monitoring unit 100 includes the routing member 60 interposed between the second terminal fitting 50 and the unit body, and indirectly electrically connects the second terminal fitting 50 to the unit body of the battery monitoring unit 100 via the routing member 60.

The routing member 60 includes, for example, a conductor portion 61 having one end portion directly electrically connected to the second terminal fitting 50 and the other end portion electrically connected directly or indirectly to the battery monitoring unit 100. In the routing member 60, the conductor portion 61 is covered with an electrically insulating insulating sheath 62. The routing member 60 described here is a linear conductor having the conductor portion 61 formed in a linear shape. Specifically, the routing member 60 is an electric wire in which a core wire as the conductor portion 61 is covered with an electrically insulating insulating sheath 62, and the joint portion 52 is joined to one end portion of the conductor portion 61 at the terminal thereof.

For example, the insulating sheath 62 is peeled off at one end portion of the routing member 60, and the joint portion 52 is joined to the conductor portion 61 exposed from the insulating sheath 62. In this case, the joint portion 52 is configured as, for example, a crimp portion to be crimped and fixed to one end portion of the conductor portion 61. Note that the joint portion 52 is not limited to this example, and may be joined to the conductor portion 61 of the routing member 60 by, for example, laser welding, ultrasonic bonding, pressure welding, soldering, or the like. In addition, for example, the routing member 60 may be a member in which one end portion of the conductor portion 61 is covered with the insulating sheath 62 at the terminal. In this case, the joint portion 52 may be configured as a pair of pressure welding blades that makes a cut in the insulating sheath 62 at the end portion of the routing member 60 and sandwiches one end portion of the conductor portion 61 (core wire of the end portion of the electric wire).

In the present embodiment, the battery monitoring unit 100 is an example of a second electrical connection object connected to the second terminal fitting 50. The second terminal fittings 50 are disposed on a straight line at intervals in the alignment direction X with respect to the first terminal fittings 40. In the second terminal fitting 50, for example, the second electrical connection portion 51 and the joint portion 52 are adjacent to each other in the alignment direction X. The joint portion 52 is configured to pull out the routing member 60 toward one end in the alignment direction X.

Note that the routing member 60 may be, for example, a flat routing member such as a flexible printed circuit board in which the conductor portion 61 is formed as a wiring pattern. In this case, the routing member 60 has the conductor portion 61 for each of the second terminal fittings 50 in the plurality of fuse units 20, and one end portion of the conductor portion 61 is provided at a terminal of a branch portion branched from the main body for each of the second terminal fittings 50. The one end portion of the conductor portion 61 is directly electrically connected to the joint portion 52 by, for example, laser welding, soldering, or the like.

Here, in the fuse unit 20, the first electrical connection portion 41 of the first terminal fitting 40 and the second electrical connection portion 51 of the second terminal fitting 50 are disposed on the same plane at predetermined intervals along the alignment direction X. The predetermined interval is an interval (in other words, the inter-electrode pitch) between the first electrode 31 and the second electrode 32 in the chip fuse 30. Therefore, the first terminal fitting 40 and the second terminal fitting 50 are disposed so that the interval between the first electrical connection portion 41 and the second electrical connection portion 51 matches the inter-electrode pitch between the first electrode 31 and the second electrode 32. The chip fuse 30 is installed across the first electrical connection portion 41 and the second electrical connection portion 51. Here, the first terminal fitting 40 and the second terminal fitting 50 are disposed so that the interval between the contact portion 41a of the first electrical connection portion 41 and the contact portion 51a of the second electrical connection portion 51 matches the inter-electrode pitch between the first electrode 31 and the second electrode 32.

The resin member 70 protects the chip fuse 30, for example, by covering the periphery of the chip fuse 30. The resin member 70 is made of, for example, an electrically insulating resin material, and houses the first electrical connection portion 41, the second electrical connection portion 51, and the chip fuse 30. That is, the resin member 70 is provided with a housing chamber 70a in which the first electrical connection portion 41, the second electrical connection portion 51, and the chip fuse 30 are housed.

The resin member 70 includes, for example, a plurality of housing members that is assembled and fixed to each other to form the housing chamber 70a inside. Specifically, the resin member 70 includes, as a plurality of housing members, a first housing member 70A and a second housing member 70B that sandwich the first electrical connection portion 41, the second electrical connection portion 51, and the chip fuse 30 between each other and house them in the housing chamber 70a. The first housing member 70A and the second housing member 70B are formed of, for example, an electrically insulating material such as synthetic resin. The first housing member 70A and the second housing member 70B are formed as members separate from the first electrical connection portion 41, the second electrical connection portion 51, and the chip fuse 30, and surround the first electrical connection portion 41, the second electrical connection portion 51, and the chip fuse 30 to house them in the housing chamber 70a.

The first housing member 70A includes, for example, an installation face 71 on which the first electrical connection portion 41 and the second electrical connection portion 51 are placed. The chip fuse 30 is placed on the first electrical connection portion 41 and the second electrical connection portion 51 placed on the installation face 71. Here, for example, the first housing member 70A is formed as a base member for placing the first electrical connection portion 41 and the second electrical connection portion 51 on the installation face 71. The first housing member 70A illustrated here is formed in a rectangular flat plate shape.

For example, the second housing member 70B is formed as a cover member that covers the first electrical connection portion 41, the second electrical connection portion 51, and the chip fuse 30 at an assembly completion position with respect to the first housing member 70A as a base member. The second housing member 70B has a lid portion 72 disposed to face the installation face 71 of the first housing member 70A with the first electrical connection portion 41, the second electrical connection portion 51, and the chip fuse 30 interposed therebetween at the assembly completion position. The lid portion 72 shown here is formed in a rectangular flat plate shape, and is disposed parallel to the installation face 71 of the first housing member 70A at the assembly completion position.

In addition, the second housing member 70B has a pair of first side wall portions 73 that is suspended from the lid portion 72 along the height direction Z and is disposed with a space therebetween along the alignment direction X in which the first electrical connection portion 41 and the second electrical connection portion 51 face each other. The first side wall portion 73 illustrated here is formed in a rectangular flat plate shape, and the side portion at the distal end contacts the installation face 71 of the first housing member 70A at the assembly completion position. However, a first cutout 73a for drawing out the conductor connection portion 42 of the first electrical connection portion 41 to the outside of the housing chamber 70a is formed at the side portion of the distal end of the one first side wall portion 73. Further, a second cutout 73b for drawing out the joint portion 52 of the second electrical connection portion 51 to the outside of the housing chamber 70a is formed at the side portion of the distal end of the other first side wall portion 73.

In addition, the second housing member 70B has a pair of second side wall portions 74 that is suspended from the lid portion 72 along the height direction Z and disposed to face each other with a space therebetween along the width direction Y. The second side wall portion 74 illustrated here is formed in a rectangular flat plate shape, and the side portion at the distal end contacts the installation face 71 of the first housing member 70A at the assembly completion position. The second housing member 70B has an internal space surrounded by the lid portion 72, the pair of first side wall portions 73, and the pair of second side wall portions 74. In the resin member 70, when the first housing member 70A and the second housing member 70B are at the assembly completion position, the opening of the internal space of the second housing member 70B is closed by the first housing member 70A to become the housing chamber 70a.

Further, in the resin member 70, for example, the side portion at the distal end of the pair of first side wall portions 73 and the side portion at the distal end of the pair of second side wall portions 74 are fixed to the installation face 71 of the first housing member 70A by thermal welding or the like at the assembly completion position. In addition, it is desirable that the first housing member 70A and the second housing member 70B are formed and fixed in a shape in which a gap therebetween can be eliminated at the assembly completion position so as to form a space in which the housing chamber 70a is enclosed at the assembly completion position, for example. As a result, the fuse unit 20 can suppress entry of liquid, dust, and the like into the housing chamber 70a, and thus, it is possible to suppress deterioration in quality, deterioration in durability, and the like due to the entry of the liquid and the like.

Here, in the present embodiment, at least one of the first terminal fitting 40 and the second terminal fitting 50 has an extendable shape portion 90 that allows the at least one of them to extend and contract along the alignment direction X. Specifically, in the present embodiment, the second terminal fitting 50 where the joint portion 52 joined to the routing member 60 is provided has the extendable shape portion 90. The extendable shape portion 90 includes, for example, a pair of slits 91 provided in an intermediate portion between the second electrical connection portion 51 and the joint portion 52 in the second terminal fitting 50. The pair of slits 91 is provided at intervals along the alignment direction X, penetrates the second terminal fitting 50 along the height direction Z, and extends along the width direction Y. In the present embodiment, one of the pair of slits 91 is provided at one end portion of the second terminal fitting 50 in the width direction Y, and extends from the one end portion toward the other end portion in the width direction Y. The other of the pair of slits 91 is provided at the other end portion of the second terminal fitting 50 in the width direction Y, and extends from the other end portion toward the one end portion in the width direction Y. That is, the pair of slits 91 opens in directions opposite to each other along the width direction Y.

In the present embodiment, the pair of slits 91 are provided at positions of the second terminal fitting 50, the position being exposed to the outside of the resin member 70. That is, the pair of slits 91 does not overlap the resin member 70 along the height direction Z and is positioned to be shifted along the alignment direction X. The pair of slits 91 function, for example, as deformation allowing portions (extendable shape portions 90) that allow deformation and expansion and contraction of the second terminal fittings 50 along the alignment direction X. As a result, it is possible to absorb the tolerance along the alignment direction X between the connection conductor 10 connected to the first terminal fitting 40 and the routing member 60 of the battery monitoring unit 100 connected to the second terminal fitting 50. The pair of slits 91 is provided between the joint portion 52 and the chip fuse 30. As a result, for example, when the joint portion 52 and the routing member 60 are fixed by the above-described crimping, the pair of slits 91 can suppress transmission of an impact generated at the time of crimping to the chip fuse 30 by expanding and contracting the second terminal fitting 50 along the alignment direction X. Furthermore, for example, when the joint portion 52 and the routing member 60 are joined by the laser welding, ultrasonic joining, pressure welding, or the like described above, the pair of slits 91 can also suppress transmission of the heat generated at the time of the joining to the chip fuse 30 by expanding and contracting the second terminal fitting 50 along the alignment direction X.

In the present embodiment, the case where the joint portion 52 and the routing member 60 are joined by crimping or the like after the chip fuse 30 is mounted on the second terminal fitting 50 and the first terminal fitting 40 has been exemplified, but the present invention is not limited to this example. For example, the chip fuse 30 may be mounted on the second terminal fitting 50 and the first terminal fitting 40 after the joint portion 52 and the routing member 60 are joined by crimping or the like.

In the fuse unit 20 of the present embodiment having the above configuration, for example, the first electrical connection portion 41 and the second electrical connection portion 51 are installed on the installation face 71 of the first housing member 70A. The first electrode 31 and the contact portion 41a of the first electrical connection portion 41 are connected by laser welding, soldering, or the like, and the second electrode 32 and the contact portion 51a of the second electrical connection portion 51 are connected by laser welding, soldering, or the like.

At this time, in the fuse unit 20 of the present embodiment, the first housing member 70A is a base member, and there is no wall portion or the like that covers the surroundings of the first electrical connection portion 41, the second electrical connection portion 51, and the chip fuse 30 installed on the installation face 71. Therefore, in the fuse unit 20, the laser irradiator and the soldering iron can be brought close to the first electrode 31 and the contact portion 41a of the first electrical connection portion 41 and the second electrode 32 and the contact portion 51a of the second electrical connection portion 51 from various directions. As a result, it is possible to irradiate the space between the first electrode 31 and the contact portion 41a and the space between the second electrode 32 and the contact portion 51a with laser light from all directions, or to perform soldering with a soldering iron from all directions therebetween. Therefore, the fuse unit 20 can increase the degree of freedom in manufacturing when the first electrical connection portion 41, the second electrical connection portion 51, and the chip fuse 30 are directly electrically connected.

Subsequently, in the fuse unit 20 of the present embodiment, the second housing member 70B covers the first electrical connection portion 41, the second electrical connection portion 51, and the chip fuse 30, and the first housing member 70A and the second housing member 70B at the assembly completion position are fixed by thermal welding or the like. As a result, the chip fuse 30, the first terminal fitting 40, the second terminal fitting 50, the resin member 70, and the like can be assembled to manufacture the fuse unit 20.

In FIG. 1, the conductive module 1 includes an electrically insulating module resin portion 80 in which the fuse unit 20 is housed together with the connection conductor 10. The module resin portion 80 is provided with a conductor housing chamber 80a that houses the connection conductor 10 and a unit housing chamber 80b that houses the fuse unit 20. For example, the module resin portion 80 has the conductor housing chamber 80a for each of the connection conductors 10 connected to the respective electrode terminals BCb of the electrode terminal group BCc. On the other hand, the module resin portion 80 has the unit housing chamber 80b in which the fuse unit 20 for each of the connection conductors 10 is collectively housed.

In the unit housing chamber 80b, the routing member 60 of each fuse unit 20 is routed to the unit body of the battery monitoring unit 100. In each routing member 60, the other end of the destination routed to the unit body of the battery monitoring unit 100 is connected to a connector 65. Then, each routing member 60 is indirectly electrically connected to the unit body of the battery monitoring unit 100 via the connector 65.

The module resin portion 80 includes a first module housing member 80A and a second module housing member (not illustrated) that are assembled and fixed to each other to form a plurality of conductor housing chambers 80a and a plurality of unit housing chambers 80b inside. The first module housing member 80A and the second module housing member are formed of an electrically insulating material such as a synthetic resin. The first module housing member 80A has a space portion for forming a plurality of conductor housing chambers 80a and a plurality of unit housing chambers 80b. The second module housing member is formed as a cover member that covers the opening of each space portion.

As described above, the fuse unit 20 and the conductive module 1 according to the present embodiment include the extendable shape portion 90 that is provided at at least one of the first terminal fitting 40 and the second terminal fitting 50 and enables the at least one of them to extend and contract along the alignment direction X of the first terminal fitting 40 and the second terminal fitting 50. With this configuration, the fuse unit 20 and the conductive module 1 can absorb a tolerance along the alignment direction X between the connection conductor 10 (first connection object) and the routing member 60 of the battery monitoring unit 100 (second connection object) by extension and contraction of the extendable shape portion 90, for example. As a result, the fuse unit 20 and the conductive module 1 can ensure an appropriate connection state with respect to the connection conductor 10 and the routing member 60 of the battery monitoring unit 100.

In the fuse unit 20 of the present embodiment, the second terminal fitting 50 includes the joint portion 52 joined to the routing member 60 of the battery monitoring unit 100, and the extendable shape portion 90 includes the slit 91 provided at the second terminal fitting 50 and extending along the width direction Y intersecting the alignment direction X. With this configuration, in the fuse unit 20, for example, the second terminal fitting 50 can be expanded and contracted along the alignment direction X by the slit 91, and eventually, it is possible to suppress transmission of an impact, heat, and the like generated at the time of joining the joint portion 52 and the routing member 60 to (the solder portion of) the chip fuse 30.

In addition, the fuse unit 20 of the present embodiment includes the insulating resin member 70 that covers the chip fuse 30 installed across the first electrical connection portion 41 and the second electrical connection portion 51, and the extendable shape portion 90 is provided outside the resin member 70. With this configuration, in the fuse unit 20, for example, the extendable shape portion 90 can be provided away from the chip fuse 30, and eventually, it is possible to suppress a decrease in rigidity or strength of the second electrical connection portion 51 of the second terminal fitting 50 as at least one of the first terminal fitting 40 and the second terminal fitting 50 or a portion close to the chip fuse 30.

### First modification

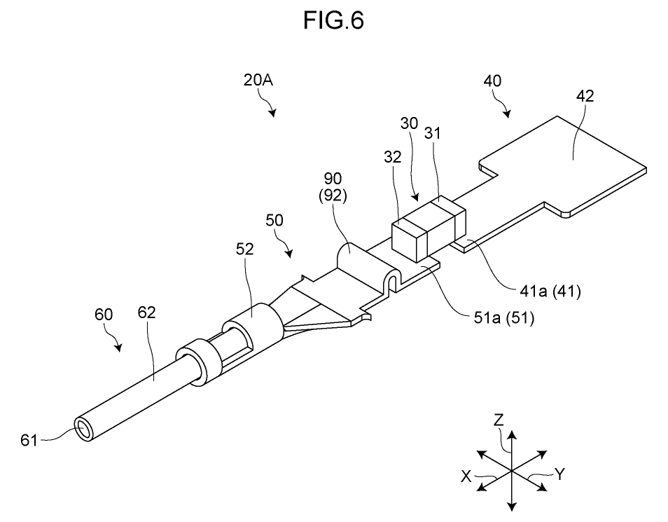

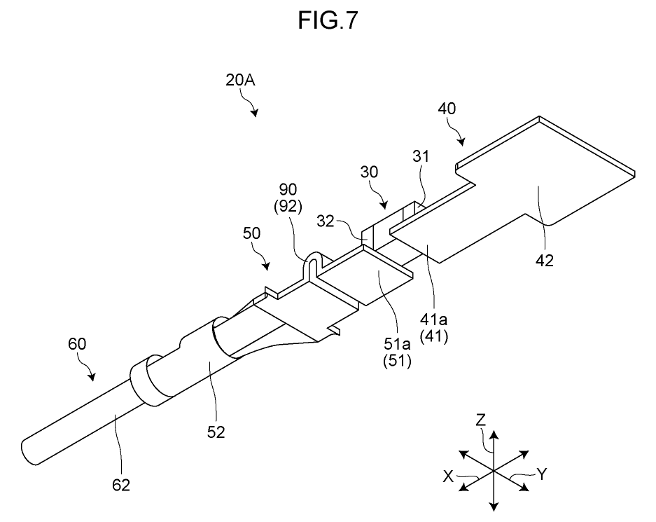

FIG. 6 is a perspective view of a fuse unit 20A according to a first modification, and FIG. 7 is a perspective view of a fuse unit 20A when viewed from an angle different from that in FIG. 6. The fuse unit 20A illustrated in FIGS. 6 and 7 has the same configuration as the fuse unit 20 of the above embodiment. Therefore, the fuse unit 20A can obtain the same operation and effect as those of the above embodiment based on the same configuration.

However, as illustrated in FIGS. 6 and 7, the present modification is different from the above-described embodiment in that the extendable shape portion 90 includes a curved portion 92 provided at the second terminal fitting 50 and curved along the height direction Z. The curved portion 92 is provided, for example, at an intermediate portion between the second electrical connection portion 51 and the joint portion 52 of the second terminal fitting 50, and is curved in a protruding state toward one end portion (upper side) in the height direction Z. The curved portion 92 has, for example, a substantially U-shaped cross-sectional shape opened toward the other end portion (lower side) in the height direction Z, and is provided across one end portion and the other end portion of the second terminal fitting 50 in the width direction Y. The curved portion 92 is referred to as, for example, a folded curved portion obtained by curving the intermediate portion of the second terminal fitting 50 so as to fold back the intermediate portion along the height direction Z, a bellows-shaped portion obtained by curving the intermediate portion in a bellows shape (wavy shape), or the like. The curved portion 92 functions, for example, as a deformation allowing portion (extendable shape portion 90) that allows deformation and expansion and contraction of the second terminal fittings 50 along the alignment direction X.

The present modification is different from the above embodiment in that the resin member 70 (see FIG. 3) covering the chip fuse 30 is not provided. The chip fuse 30 is covered and protected by the second module housing member (cover) of the module resin portion 80 described above, for example, in a state where the fuse unit 20 is mounted on the conductive module 1 (see FIG. 1). In the present modification, the case where the second terminal fitting 50 has one curved portion 92 has been exemplified, but the present invention is not limited to this example, and for example, the second terminal fitting 50 may have a plurality of curved portions 92 at intervals along the alignment direction X.

As described above, in the fuse unit 20A of the present modification, the second terminal fitting 50 includes the joint portion 52 joined to the routing member 60 of the battery monitoring unit 100, and the extendable shape portion 90 includes the curved portion 92 provided at the second terminal fitting 50 and curved along the height direction Z intersecting the alignment direction X. With this configuration, in the fuse unit 20A, for example, the second terminal fitting 50 can be expanded and contracted along the alignment direction X by the curved portion 92, and eventually, it is possible to suppress transmission of an impact, heat, and the like generated at the time of joining the joint portion 52 and the routing member 60 to (the solder portion of) the chip fuse 30.

### Second modification

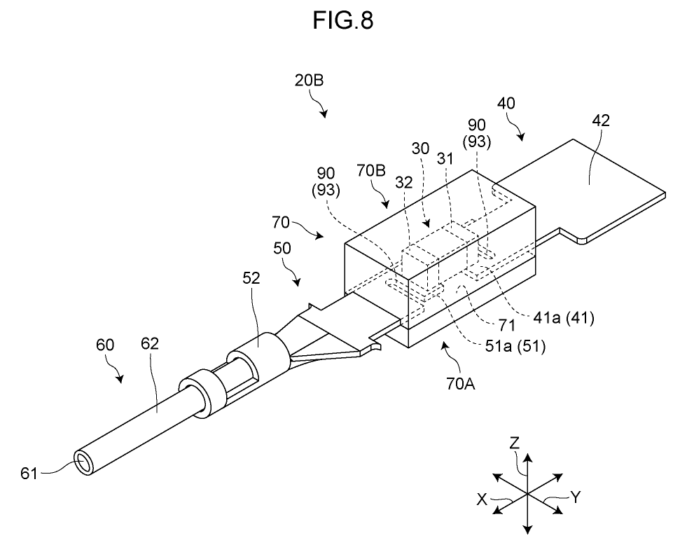

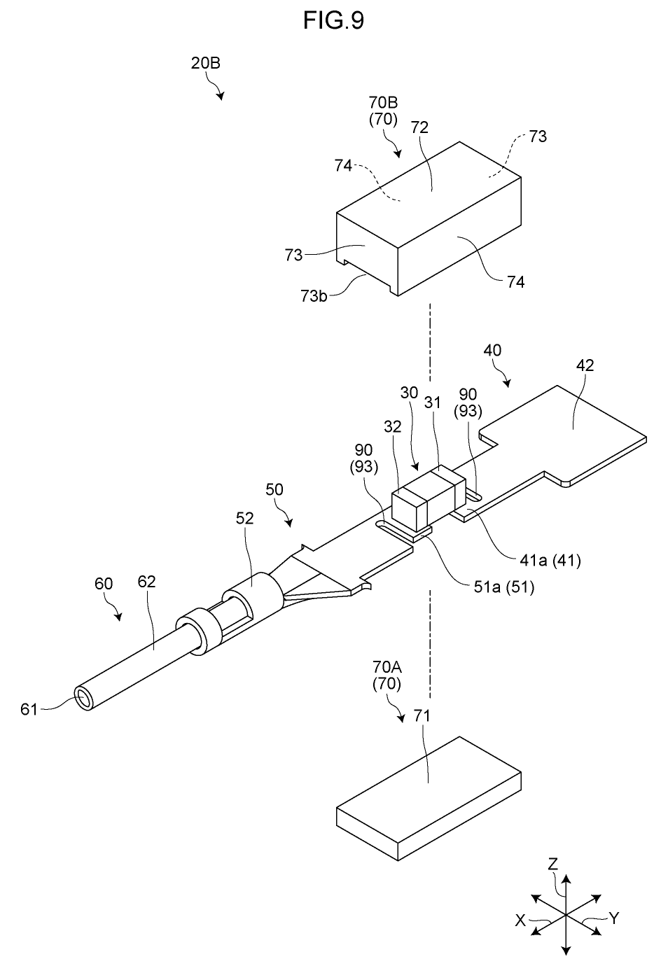

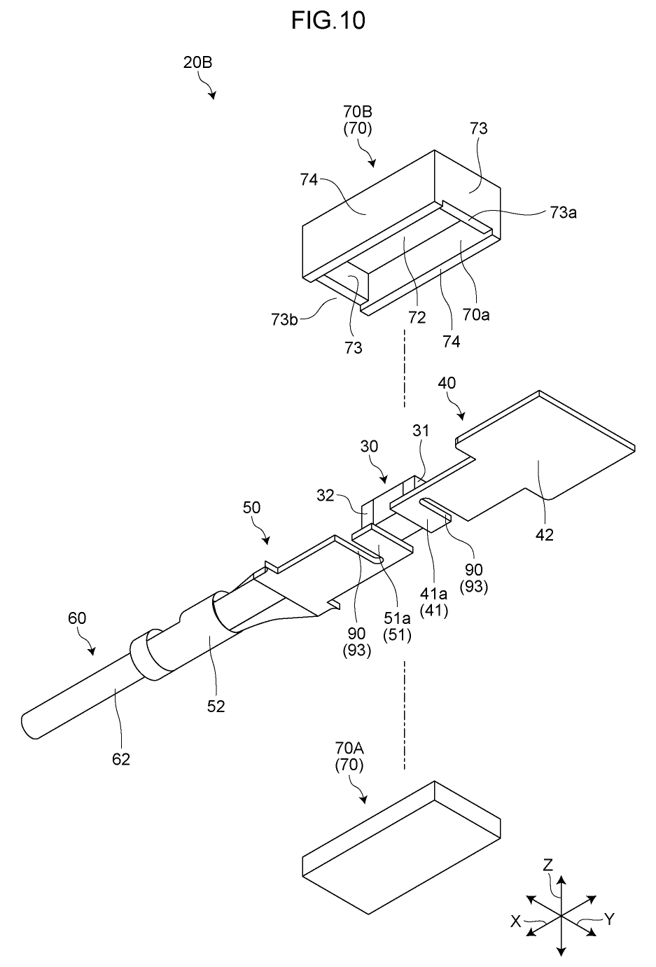

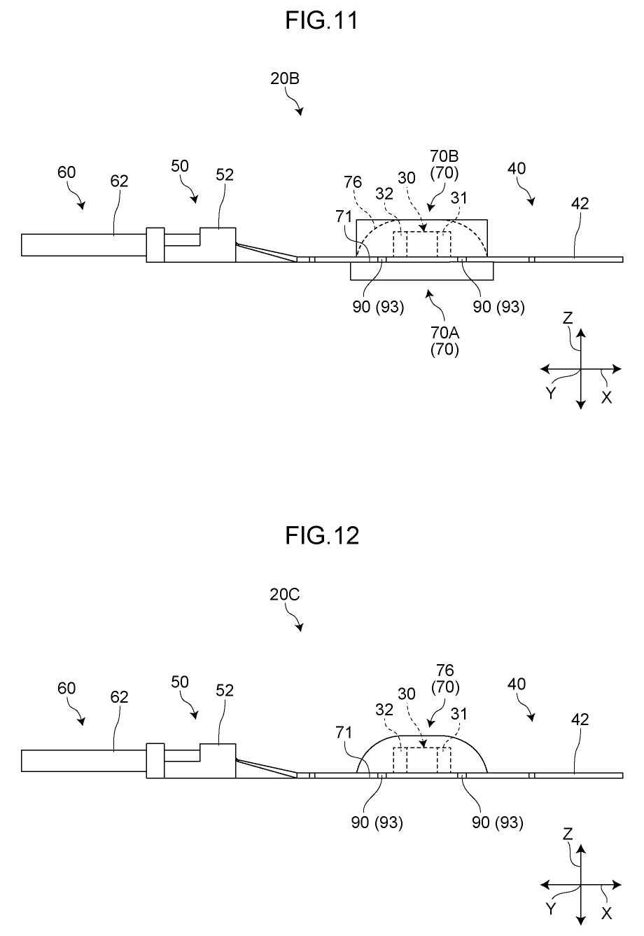

FIG. 8 is a perspective view of a fuse unit 20B according to the second modification, FIG. 9 is an exploded perspective view of the fuse unit 20B, FIG. 10 is an exploded perspective view of the fuse unit 20B when viewed from an angle different from that in FIG. 9, and FIG. 11 is a side view of the fuse unit 20B. A fuse unit 20B illustrated in FIG. 8 to 11 has the same configuration as the fuse unit 20 of the above embodiment. Therefore, the fuse unit 20B can obtain the same operation and effect as those of the above embodiment based on the same configuration.

However, as illustrated in FIG. 8 to 11, the present modification is different from the above-described embodiment in that the extendable shape portion 90 includes a pair of slits 93 provided at the first terminal fitting 40 and the second terminal fitting 50, respectively, and extending along the width direction Y. The pair of slits 93 is provided, for example, in a proximity portion of the first electrical connection portion 41 in the first terminal fitting 40 and in a proximity portion of the second electrical connection portion 51 in the second terminal fitting 50. The pair of slits 93 is provided at intervals along the alignment direction X, penetrates the first terminal fitting 40 and the second terminal fitting 50 along the height direction Z, and extends along the width direction Y.

In the present modification, one of the pair of slits 93 is provided at one end portion of the second terminal fitting 50 in the width direction Y, and extends from the one end portion toward the other end portion in the width direction Y. The other of the pair of slits 93 is provided at the other end portion of the first terminal fitting 40 in the width direction Y, and extends from the other end portion toward the one end portion in the width direction Y. That is, the pair of slits 93 opens in directions opposite to each other along the width direction Y. The pair of slits 93 function as, for example, a deformation allowing portion (extendable shape portion 90) that allows deformation and expansion and contraction of each of the first terminal fitting 40 and the second terminal fitting 50 along the alignment direction X of the first terminal fitting 40 and the second terminal fitting 50.

Further, in the present modification, the pair of slits 93 is provided at positions overlapping the inside of the resin member 70 at the first terminal fitting 40 and the second terminal fitting 50. That is, the pair of slits 93 is positioned to overlap the resin member 70 along the height direction Z. In the present modification, for example, an electrically insulating resin-covered portion 76 (see FIG. 11) enclosing the chip fuse 30, the first electrical connection portion 41, and the second electrical connection portion 51 is provided inside the resin member 70.

The resin-covered portion 76 encloses, for example, the chip fuse 30, the first electrical connection portion 41, and the second electrical connection portion 51, thereby suppressing energization between the first electrical connection portion 41 and the second electrical connection portion 51. For example, even when dew condensation occurs in the housing chamber 70a of the resin member 70, the resin-covered portion 76 can suppress a short circuit in the housing chamber 70a due to the dew condensation water. In addition, the resin-covered portion 76 functions as, for example, a fixing member that fixes the first electrical connection portion 41, the second electrical connection portion 51, and the chip fuse 30 to the first housing member 70A and the second housing member 70B in the housing chamber 70a.

The resin-covered portion 76 is, for example, a solidified material with which the housing chamber 70a is filled and encloses the chip fuse 30, the first electrical connection portion 41, and the second electrical connection portion 51. In this case, for example, any one of the first housing member 70A and the second housing member 70B has a supply hole (not illustrated) for supplying a liquid resin material to the inside of the first housing member 70A and the second housing member 70B (housing chamber 70a) at the assembly completion position. Here, when there is no gap between the first housing member 70A and the second housing member 70B at the assembly completion position, that is, when the airtightness of the housing chamber 70a is high, either one of the first housing member 70A and the second housing member 70B has an air vent hole (not illustrated) for releasing the gas in the housing chamber 70a to the outside of the chamber during supply of the liquid resin material.

Then, a liquid resin material is supplied and filled from the supply hole to the inside (housing chamber 70a) of the first housing member 70A and the second housing member 70B at the assembly completion position and the resin material is cured to form the resin-covered portion 76. At this time, part of the resin material is supplied to the pair of slits 93, and the pair of slits 93 is filled with the resin material. In a case where there is a concern that the liquid resin material may flow out from the housing chamber 70a, such as when there is a gap between the first housing member 70A and the second housing member 70B at the assembly completion position (when the airtightness of the housing chamber 70a is low), or when there is a need to provide, for example, a supply hole or an air vent hole at the other end portion (lower side) in the height direction Z, it is desirable to form the resin-covered portion 76 using a liquid resin material having a viscosity that can be stopped in the housing chamber 70a until it is cured.

As described above, in the fuse unit 20B of the present modification, the extendable shape portion 90 includes the pair of slits 93 provided at the first terminal fitting 40 and the second terminal fitting 50, respectively, and extending along the width direction Y. With this configuration, in the fuse unit 20B, for example, each of the first terminal fitting 40 and the second terminal fitting 50 can be expanded and contracted along the alignment direction X by the pair of slits 93. In addition, for example, the slit 93 provided at the second terminal fitting 50 can suppress transmission of an impact, heat, or the like generated at the time of joining the joint portion 52 and the routing member 60 to (the solder portion of) the chip fuse 30.

Further, in the fuse unit 20B of the present modification, the extendable shape portion 90 is provided inside the resin member 70. With this configuration, the fuse unit 20B can absorb, for example, displacement of the distance between the terminals between the first terminal fitting 40 and the second terminal fitting 50 due to thermal deformation of the resin member 70 (deformation due to a difference in linear expansion coefficient). In addition, for example, by filling the pair of slits 93 of the extendable shape portion 90 with the resin-covered portion 76 of the resin member 70, displacement of the distance between the terminals between the first terminal fitting 40 and the second terminal fitting 50 can be further absorbed.

FIG. 12 is a side view of a fuse unit 20C according to a third modification. A fuse unit 20C illustrated in FIG. 12 has the same configuration as the fuse unit 20 of the above embodiment. Therefore, the fuse unit 20C can obtain the same operation and effect as those of the above embodiment based on the same configuration.

However, the present modification is different from the above-described embodiment in that the resin member 70 is formed only of the resin-covered portion 76 as illustrated in FIG. 12. That is, in the present modification, the resin member 70 does not have the first housing member 70A and the second housing member 70B in a case shape, and the periphery of the chip fuse 30, the first electrical connection portion 41, and the second electrical connection portion 51 is covered with the resin-covered portion 76.

The resin-covered portion 76 is, for example, a solidified material of a liquid resin material (so-called potting material) supplied by dropping or the like so as to wrap the chip fuse 30, the first electrical connection portion 41, and the second electrical connection portion 51. In this case, first, a liquid potting material is supplied to the chip fuse 30, the first electrical connection portion 41, and the second electrical connection portion 51. Thereafter, the resin-covered portion 76 in which the potting material is cured is formed by irradiating the potting material with ultraviolet rays or heating the potting material according to the properties of the potting material. Since the resin-covered portion 76 undergoes such a manufacturing process, it is desirable to form the resin-covered portion using a liquid potting material having a viscosity that can remain on the first terminal fitting 40 and the second terminal fitting 50 until curing so that the liquid potting material does not flow out from the first terminal fitting 40 and the second terminal fitting 50 before curing.

Here, in the case of the ultraviolet curing type potting material, it is necessary to bring the ultraviolet irradiator close to the liquid potting material. In the present modification, the first terminal fitting 40 and the second terminal fitting 50 are base members, and there is no wall portion or the like that covers the surroundings of the supplied liquid potting material. Therefore, in the fuse unit 20C, the ultraviolet irradiator can be brought close to the liquid potting material from various directions on the first terminal fitting 40 and the second terminal fitting 50, and the ultraviolet ray can be radiated from all directions toward the liquid potting material. Therefore, the fuse unit 20C can increase the degree of freedom in manufacturing when the resin-covered portion 76 is formed.

In the above embodiment and the above modification, the case where the second terminal fitting 50, or each of the second terminal fitting 50 and the first terminal fitting 40 has the extendable shape portion 90 has been exemplified, but the present invention is not limited to this example, and for example, only the first terminal fitting 40 may have the extendable shape portion 90. Further, for example, the resin-covered portion 76 covering the chip fuse 30 may be formed by resin molding. Specifically, the first terminal fitting 40 and the second terminal fitting 50 may be assembled to the first housing member 70A, and the insert molding may be performed for a component, as an insert, obtained by connecting the chip fuse 30 between the first terminal fitting 40 and the second terminal fitting 50 to form the resin-covered portion 76. In addition, the insert molding may be performed for a component, as an insert, obtained by connecting the chip fuse 30 between the first terminal fitting 40 and the second terminal fitting 50 to form a portion of the resin-covered portion 76 and the first housing member 70A.

Although the embodiment and the modification of the present invention have been exemplified above, the embodiment and the modification are merely examples, and are not intended to limit the scope of the invention. The above-described embodiment and modification can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

The fuse unit and the conductive module according to the present embodiment have an effect of being able to ensure an appropriate connection state with respect to the first electrical connection object and the second electrical connection object.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a chip fuse that fuses a fusible portion when an overcurrent flows between a first electrical connection object and a second electrical connection object;
a first terminal fitting including a first electrical connection portion electrically connected to a first electrode of the chip fuse, and electrically connected to the first electrical connection object;
a second terminal fitting including a second electrical connection portion electrically connected to a second electrode of the chip fuse, and electrically connected to the second electrical connection object; and
an extendable shape portion provided at at least one of the first terminal fitting and the second terminal fitting, the extendable shape portion enabling the at least one of the first terminal fitting and the second terminal fitting to extend and contract along an alignment direction of the first terminal fitting and the second terminal fitting.

2. The fuse unit according to claim 1, wherein
the second terminal fitting includes a joint portion joined to a routing member of the second electrical connection object, and
the extendable shape portion includes a slit provided at the second terminal fitting and extending along a width direction intersecting the alignment direction.

3. The fuse unit according to claim 1, wherein
the second terminal fitting includes a joint portion joined to a routing member of the second electrical connection object, and
the extendable shape portion includes a curved portion provided at the second terminal fitting and curved along a height direction intersecting the alignment direction.

4. The fuse unit according to claim 1, wherein
the extendable shape portion includes a pair of slits provided at the first terminal fitting and the second terminal fitting, respectively, and extending along a width direction intersecting the alignment direction.

5. The fuse unit according to claim 1, further comprising:
an insulating resin member that covers the chip fuse installed across the first electrical connection portion and the second electrical connection portion, wherein
the extendable shape portion is provided outside the resin member.

6. The fuse unit according to claim 2, further comprising:
an insulating resin member that covers the chip fuse installed across the first electrical connection portion and the second electrical connection portion, wherein
the extendable shape portion is provided outside the resin member.

7. The fuse unit according to claim 1, further comprising:
an insulating resin member that covers the chip fuse installed across the first electrical connection portion and the second electrical connection portion, wherein
the extendable shape portion is provided inside the resin member.

8. The fuse unit according to claim 4, further comprising:
an insulating resin member that covers the chip fuse installed across the first electrical connection portion and the second electrical connection portion, wherein
the extendable shape portion is provided inside the resin member.

9. A conductive module comprising:
a connection conductor electrically connected to an electrode terminal of a battery cell constituting a battery module; and
a fuse unit that electrically connects the connection conductor to a battery monitoring unit that monitors a battery state of the battery cell, wherein
the fuse unit includes
a chip fuse that fuses a fusible portion when an overcurrent flows between the connection conductor and the battery monitoring unit,
a first terminal fitting including a first electrical connection portion electrically connected to a first electrode of the chip fuse and electrically connected to the connection conductor,
a second terminal fitting including a second electrical connection portion electrically connected to a second electrode of the chip fuse and electrically connected to the battery monitoring unit, and
an extendable shape portion provided at at least one of the first terminal fitting and the second terminal fitting, the extendable shape portion enabling the at least one of the first terminal fitting and the second terminal fitting to extend and contract along an alignment direction of the first terminal fitting and the second terminal fitting.
